(19) United States
(12) Patent Application Publication
(10) Pub. No.: US 2018/0130370 A1
(43) Pub. Date: May 10, 2018

(54) Identifying fingers in learning computer keyboarding

(71) Applicant: Istvan Szent-Miklosy, New York, NY (US)

(72) Inventor: Istvan Szent-Miklosy, New York, NY (US)

(21) Appl. No.: 15/657,341

(22) Filed: Jul. 24, 2017

Related U.S. Application Data
(60) Provisional application No. 62/365,959, filed on Jul. 22, 2016.

(51) Int. Cl. G09B 13/00; G06K 9/00; G09B 5/06

(52) U.S. Cl. CPC G09B 13/00; G09B 5/06; G06K 9/00355

(57) ABSTRACT

A method and apparatus for learning computer keyboarding is disclosed in which the system determines which finger a user has used to press a particular key. The system comprises a real-time feed from a video camera, a means of analyzing the feed to determine the finger used to press any given key, and an app. The video feed captures the user's hands, as the fingers hover over and press particular keys on the keyboard. The system analyzes by one of a variety of methods the pixel region in the video feed corresponding to a particular key, and is thereby able to recognize which finger was used to press the indicated key. The system decreases the time required to gain proficiency in computer keyboarding by providing immediate feedback of incorrect finger use.

### CROSS-REFERENCE TO RELATED APPLICATIONS

This application claims the benefit of priority to U.S. Provisional Patent Application No. 62/365,959 filed Jul. 22, 2016 titled “IDENTIFYING FINGERS IN LEARNING COMPUTER KEYBOARDING”.

### REFERENCES CITED

### U.S. Patent Documents

| | | | |
|---|---|---|---|
| 4,055,905 | November 1977 | Budrose | 434/229 |
| 4,465,477 | August 1984 | AvGavaar | 434/233 |

### OTHER PUBLICATIONS

https://www.kickstarter.com/projects/2073884751/brightfingers-computer-vision-helps-correct-finger

### BACKGROUND

### 1. Field

The present invention relates to methods and apparatus for teaching computer keyboarding, also known as touch typing.

### 2. Description of Related Art

It has long been recognized that being able to detect incorrect finger use in learning keyboarding would be a substantial advantage. Students learning correct touch typing technique will still, even months into such training, exhibit incorrect finger use to a greater or lesser extent. This is due to the fact that, though they may be given guidance as to the correct finger to use, existing systems are not able to detect correct finger use.

If however a system did actively encourage correct finger use, then users would learn the proper technique significantly faster. They would be aware from the very beginning of the learning process when they were using the incorrect finger. After an initial acclimatization phase, the system might actually require correct finger use. In this case no incorrect finger muscle memory would be reinforced, i.e. by allowing the lesson to move forward and the student to continue practicing. Only correct motor movements would allow the student to progress in the lesson.

The advantage would come from the time saved learning the proper technique. Students' progress would be slower after the said acclimatization phase, as they would not be able to advance the lesson with correct keypresses that did not use the correct finger. But the overall time required to gain proficiency in this motor skill would be sizably reduced.

### SUMMARY

In accordance with an exemplary and non-limiting embodiment of the invention, the video input is configured to provide a real-time feed of the user's keyboard.

The user wears markings on his/her fingers, which can be analyzed by the system using, for example, computer vision. In one embodiment, the user wears full-fingered gloves with individually-colored fingers, with which lessons are performed.

The app has an internal map of the correct finger to be used for each key. For example the left ring finger is the correct finger for the W, S, and X keys on a US English keyboard. In one embodiment, the app also has an internal map of the expected color for each column of fingers. In this case of the left ring finger, the expected color is orange. These colors correspond to the colors applied to individual fingers on the gloves in this embodiment.

The app performs real-time analysis on the video feed, doing finger recognition on the region of pixels showing the expected key to be pressed, as specified by the current lesson. In the event that the right key has been pressed (no processing is required in the event that the wrong key has been pressed), finger recognition is performed to see if the finger above the key at the time of the keypress was the correct finger for this particular key. In one embodiment the means of this analysis/recognition is via computer vision color detection. If the color of the gloved finger seen in this pixel region of the video feed matches the color expected according to the fingers/keys map, then the lesson advances.

If the result of the analysis/recognition is that an incorrect finger was used, then the user is alerted to having used the wrong finger. This alerting can be merely visual or auditory (as in the said acclimatization phase), or it can actually halt the advance of the lesson.

To illustrate, FIG. 3 shows the user's left index finger pressing the ‘T’ key. The predominant color within the black-edged square region of pixels for the ‘T’ key seen in the video feed is dark blue, which the app will detect and recognize as the correct color for this key. If in contrast the user pressed the ‘T’ key with his/her left middle finger, then the app would detect the color yellow, and recognize that an incorrect finger had been used to press the ‘T’ key.

In accordance with another exemplary and non-limiting embodiment of the invention, finger detection is performed via so-called hand pose estimation. In this embodiment, no special markings must be worn on the fingers.

### BRIEF DESCRIPTION OF FIGURES

FIG. 1 is a diagram of the system as a whole, including hardware and software elements, as well as internal software facilities and functions.

FIG. 2 is a flowchart detailing the steps in the detection method, which is actuated every time the user performs a keystroke.

FIG. 3 is a still image taken from the live video feed, showing colored gloves as used in one embodiment. Over this actual image is drawn a superimposed black-edged square, that illustrates the pixel region to be analyzed, in this instance for the letter/key ‘T’.

FIG. 4 is an illustration of the internal fingers/keys map showing columns of keys for individual fingers. This illustration visualizes one embodiment that uses colored fingers on gloves, the expected color for each key corresponding to the finger color on the user's glove.

### DETAILED DESCRIPTION

In accordance with exemplary and non-limiting embodiments, the system disclosed herein makes it possible to alert the user when an incorrect finger has been used to press a particular key.

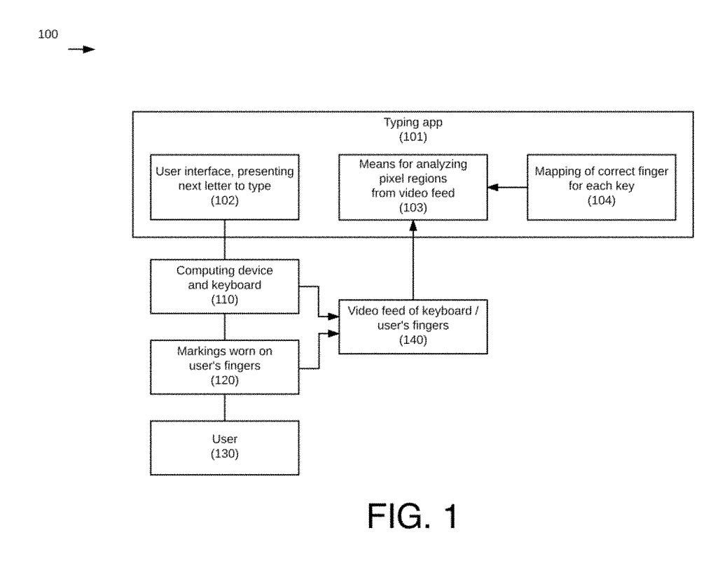

With reference to FIG. 1, the system comprises an app 101, a keyboard 110, markings the user 130 wears on his/her fingers 120, and a video feed 140. The app's user interface 102 displays a typing lesson showing the next letter the user is to type. Internally, the app has a mapping 104 that matches particular fingers with the set of keys each finger is to be used to type.

The video feed 140 routes a live image of the keyboard and user's fingers, when present, to the app for real-time analysis 103. In one embodiment, the video can come from a computing device's built-in camera, the feed of which is directed from the keyboard area by means of a mirror attached to the camera lens, which redirects the feed from the user's face down to the keyboard instead. In another embodiment, a webcam or similar device can be attached to, for example, the screen of a laptop, for devices without a built-in camera, to provide the needed video feed.

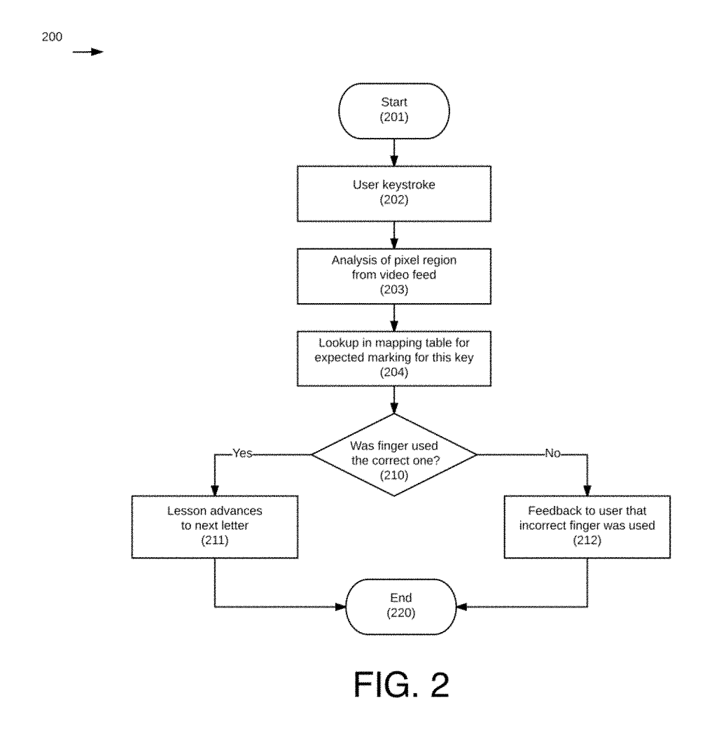

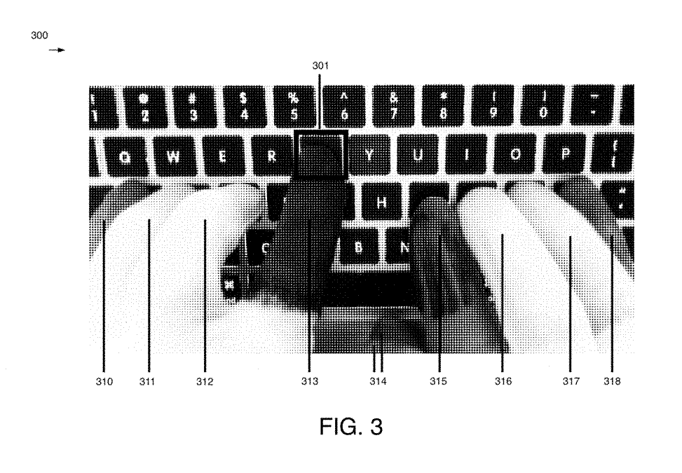

With reference to FIG. 2, the detection system is invoked 201 every time the user makes a keystroke 202. At this moment the system determines which set of pixels (see for example 301 in FIG. 3) to analyze 203. By consulting the internal mapping of fingers to keys 204, the app knows which finger marking would indicate that the correct finger was used. The system then performs this analysis in near real-time to determine whether the finger used was the correct one 210. If it was 211, then the app moves to the next letter. If it was not 212, then the app provides feedback to the user that the wrong finger was used. Either case terminates 220 one loop of the detection function.

In one embodiment, the analysis 204 is performed via color analysis of the pixel region 301. In this embodiment, gloves with colored fingers are used as the means of marking individual fingers. The analysis in this embodiment uses computer vision to determine the color of the finger used. In another embodiment, gloves with different geometric patterns are used for each finger, the computer vision function then analyzing the patterns to determine which finger was used. In a further embodiment, rings, for example, can be placed on the fingers to provide colors or patterns for the detection system to analyze.

In a further embodiment, nothing is worn on the fingers for the analysis to be performed. Instead, the system determines which finger was used using hand pose estimation.

With reference to FIG. 3, the black-edged square region 301 shows the pixels to be analyzed when the ‘T’ key is expected by the app's current lesson. Additionally, in the colored-gloves embodiment, the left pinky 310 is colored red; left ring 311 is colored orange; left middle 312 is colored yellow; left index 313 is colored dark blue; thumbs 314 are colored green; right index 315 is colored light blue; right middle 316 is colored yellow; right ring 317 is colored orange; and right pinky 318 is colored red.

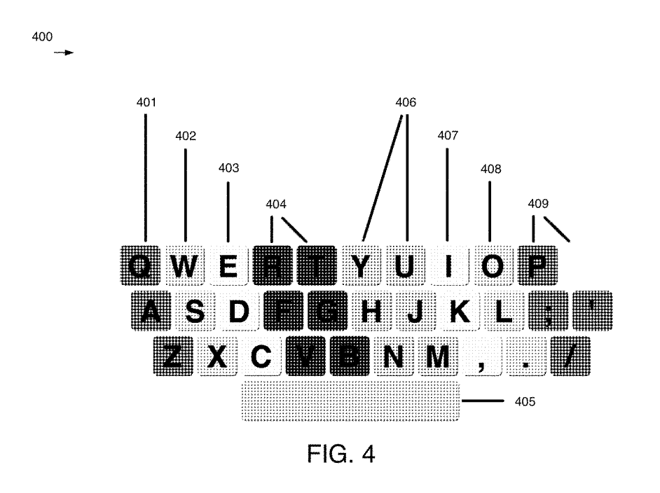

With reference to FIG. 4, and also in the in the colored-gloves embodiment, left pinky column 401 specifies ‘Q’, ‘A’, and ‘Z’ keys in red, to be pressed with the left pinky; left ring column 402 specifies ‘W’, ‘S’, and ‘X’ keys in orange, to be pressed with the left ring; left middle column 403 specifies ‘E’, ‘D’, and ‘C’ keys in yellow, to be pressed with the left middle; left index columns 404 specify ‘R’, ‘F’, ‘V’, ‘T’, ‘G’ and ‘B’ keys in dark blue, to be pressed with the left index; spacebar 405 specifies the ‘spacebar’ key to be pressed with either thumb; right index columns 406 specify ‘Y’, ‘H’, ‘N’, ‘U’, ‘J’ and ‘M’ keys in light blue, to be pressed with the right index; right middle column 407 specifies ‘I’, ‘K’, and ‘,’ keys in yellow, to be pressed with the right middle; right ring column 408 specifies ‘O’, ‘L’, and ‘.’ keys in orange, to be pressed with the right ring; and right pinky columns 409 specify ‘P’, ‘;’, ‘/’, and ′″ keys in red, to be pressed with the right pinky.

What is claimed is:

1. In a system for learning touch typing, a finger-detection method, comprising:
a. an app that presents the next letter to type to the user,
b. a live video feed of the user's keyboard,
c. machine-distinguishable markings worn on the user's fingers,
d. a mapping of the correct finger for each key on the keyboard,
e. means for analyzing in real-time the particular region of pixels in the video feed corresponding to the keyboard key of said next letter,
whereby at the time of a user's keystroke the system determines, via the analysis of the marking identified in the pixel region, and the finger/key mapping, whether the finger used to press the presented letter/key was the correct or incorrect one.

2. In a system for learning touch typing, a finger-detection method, comprising:
a. an app that presents the next letter to type to the user,
b. a live video feed of the user's keyboard,
c. a mapping of the correct finger for each key on the keyboard,
d. means for determining which finger is above the key corresponding to said next letter, via hand pose estimation,
whereby at the time of a user's keystroke the system determines, via the hand pose estimation and the finger/key mapping, whether the finger used to press the presented letter/key was the correct or incorrect one.
